(19) United States
(12) Patent Application Publication
(10) Pub. No.: US 2020/0359778 A1
(43) Pub. Date: Nov. 19, 2020

(54) TOOTHBRUSH

(71) Applicant: SEASTAR Corporation, Tokyo (JP)

(72) Inventors: Kiyotaka Yamafuji, Tokyo (JP); Ayako Yasumitsu, Tokyo (JP)

(21) Appl. No.: 15/930,932

(22) Filed: May 13, 2020

(30) Foreign Application Priority Data
May 14, 2019 (JP) 2019-091375

(51) Int. Cl. A46B 15/00; A46B 9/04

(52) U.S. Cl. CPC A46B 15/0036; A46B 9/04; F21Y 2115/10; A46B 15/0008; A46B 2200/1066; A46B 15/0044

(57) ABSTRACT

A toothbrush, which can be operated by a child, having a built-in light source, and includes an operation button that controls a light emission mode of the light source. The light source can emit light in a multicolor light mode, switchably emitting light in at least three or more colors, and a monochromatic light mode, emitting light in a particular color selected from the at least three or more colors in a fixed manner.

### BACKGROUND OF THE INVENTION

### Field of the Invention

The present invention relates to a toothbrush, and specifically relates to a toothbrush having a light emission section.

### Description of the Related Art

A primary tooth is softer than a permanent tooth, and when developing a cavity, such tooth decay progresses fast. Thus, it is important not to develop a cavity. However, tendency shows that babies and infants dislike tooth brushing, and tooth brushing for children is an issue with which parents struggle. Attempts have been made to use a toy or sing a song for entertaining a child upon tooth brushing, for example.

In recent years, not only a toothbrush for a child but also an electric toothbrush including, e.g., a built-in vibration motor or ultrasonic vibrator to vibrate the brush and an optical toothbrush including a built-in light source to irradiate the inside of the mouth with light have been used.

JP 2012-161368 A describes a mouth cleaning tool. The mouth cleaning tool supplies power from a power source to a vibration motor and a light source by ON of a power switch. A housing is vibrated by the vibration motor. The light source emits light such that the light enters a transparent shaft portion of a toothbrush head. Such light is guided to a brush portion through the transparent shaft portion, and the inside of the mouth is irradiated with the light through transparent resin bristles. Moreover, JP 2012-161368 A also describes that a two-color light-emitting diode as a two-color light source configured to emit red light and blue light is used as the light source and a color switch for switching the color of light emitted from the two-color light-emitting diode as the two-color light source is provided at a position operable from the outside of the housing.

JP 8-19427 A describes an electric toothbrush capable of visually providing enjoyment during tooth brushing. In a case formed transparent or semi-transparent, a light emission body to be flashed is provided. Moreover, JP 8-19427 A also describes that, e.g., a light color of red, green, or blue can be selected as necessary and a light emission body flashing method includes a function as an operation timer and a sensor function such as the function of flashing blue light in a case where the pressure of pressing a toothbrush body is proper during tooth brushing and flashing red light in a case where such pressure is too high.

### SUMMARY OF THE INVENTION

JP 2012-161368 A describes that, e.g., LEDs configured to emit light in other colors such as blue, green, and yellow and a white LED may be used depending on the purpose of light irradiation and the light source can flash light in various pattern or switch the color of light periodically to enhance fashionability and interest a child in mouth cleaning. However, JP 2012-161368 A fails to disclose specifically how to entertain the child.

JP 8-19427 A describes that not only an infant but also an adult can observe movement of an internal mechanism during tooth brushing, and therefore, enjoyment can be added to tooth brushing and can encourage a user to perform bothersome tooth brushing without disliking such tooth brushing. Consequently, the user can establish the habit of brushing the teeth. However, JP 8-19427 A fails to disclose that the infant actively selects the color of light while enjoying tooth brushing.

That is, in the above-described typical optical toothbrush, light is flashed in various patterns, or the color of light is selected as necessary. However, it is not assumed that the child performs operation while voluntarily enjoying tooth brushing. For this reason, the child has failed to reach establishment of the habit of actively brushing the teeth.

The present invention has been made in view of the above-described problem, and an object of the present invention is to provide a toothbrush operated by a child while the child is voluntarily enjoying such operation so that the toothbrush can be put into the mouth without refusal and the child can feel tooth brushing enjoyable.

According to the toothbrush of the present invention, the above-described problem is solved by a toothbrush including a built-in light source. The toothbrush includes a body portion configured to house the light source and a power source, a brush portion provided at a tip end portion of the body portion, a control unit configured to control a light emission mode of the light source, and an operation unit configured to control the control unit. The light source is able to emit light in a multicolor light mode for switchably emitting light in at least three or more colors and a monochromatic light mode for emitting light in a particular color selected from the at least three or more colors in a fixed manner. When the operation unit is operated in the multicolor light mode, the control unit performs such control that control of the light source transitions to the monochromatic light mode, and accordingly, the light source emits light in the color of light emitted upon operation of the operation unit.

In the toothbrush of the present invention configured as described above, a child operates the operation unit during lighting in a favorite color in the multicolor light mode for switching the color of light, and in this manner, the multicolor light mode transitions to the monochromatic light mode for emitting light in the child's favorite color. That is, the light in the child's favorite color is emitted by voluntary operation so that the toothbrush can be put into the mouth or the teeth can be brushed without refusal regardless of age in month and year. Thus, the effect of lifting the mood for tooth brushing is provided. That is, according to a child's growth status, the child can interest oneself in the toothbrush, can establish the habit of putting the toothbrush into the mouth without refusal, and can establish the habit of actively brushing the teeth.

Moreover, in the above-described configuration, the light source may be able to emit light in a white light mode for emitting white light in a fixed manner, and when the operation unit is operated in the monochromatic light mode, the control unit may perform such control that the control of the light source transitions to the white light mode.

In the above-described configuration, after the child has brushed the teeth in the monochromatic light mode for emitting light in the favorite color selected by the child, the white light with which a parent easily finishes up tooth brushing and insufficient brushing is easily checked can be emitted by simple operation.

Further, in the above-described configuration, the body portion may include a vibration source in a housing, and the control unit may supply power from the power source to the vibration source in the monochromatic light mode and the white light mode.

In the above-described configuration, when the child brushes the teeth in the monochromatic light mode for emitting light in the favorite color selected by the child or when the parent illuminates the inside of the child's mouth with the white light to finish up tooth brushing in the white light mode, vibration is transmitted from the body portion to the brush portion so that, e.g., stain, food debris, and plaque on and between the teeth can be easily removed with a favorable efficiency.

In addition, in the above-described configuration, when the color from the light source is switched from a first color to a second color in the multicolor light mode, the control unit may control the light source such that time t1 for which light is emitted in either one of the first color or the second color is longer than time t2 for which the first color is switched to the second color.

In the above-described configuration, in the multicolor light mode, the time t1 for which light is emitted in a particular color is longer than the time t2 for switching the color. Thus, even for babies and infants awkward at operating the toothbrush, favorite colors can be calmly selected.

Moreover, in the above-described configuration, the operation unit may include a single operation button, and the operation button may be operated such that the control unit performs power supply from the power source to the light source and transition from the multicolor light mode to the monochromatic light mode.

In the above-described configuration, a single button can turn on the power source and can switch the light emission mode. Thus, a device configuration can be simplified, and it is not necessary to memorize button types and functions. Thus, even babies and infants can easily perform operation.

Further, in the above-described configuration, the light source may include a red LED, a green LED, and a blue LED.

In the above-described configuration, the light source includes the LEDs of three primary colors, and therefore, three or more light colors such as seven rainbow colors of red, orange, yellow, green, blue, navy, and pink can be reproduced.

According to the toothbrush of the present invention, the child operates the operation unit during lighting in the favorite color in the multicolor light mode for switching the color of light, and in this manner, the multicolor light mode transitions to the monochromatic light mode for emitting light in the child's favorite color. That is, the light in the child's favorite color is emitted from the toothbrush by voluntary operation so that the effect of lifting such a feeling that the child wishes to put the toothbrush into the mouth or to brush the teeth can be provided. Thus, the child can establish the habit of actively brushing the teeth.

Moreover, according to the toothbrush of the present invention, after the child has interested oneself in the toothbrush or has brushed the teeth by oneself in the monochromatic light mode for emitting light in the favorite color selected by the child, the white light with which the parent easily finishes up tooth brushing and insufficient brushing is easily checked can be emitted by simple operation.

Further, according to the toothbrush of the present invention, when the child brushes the teeth in the monochromatic light mode for emitting light in the favorite color selected by the child or when the parent illuminates the inside of the child's mouth with the white light to finish up tooth brushing in the white light mode, vibration is transmitted from the body portion to the brush portion so that, e.g., stain, food debris, and plaque on and between the teeth can be easily removed with a favorable efficiency.

In addition, according to the toothbrush of the present invention, in the multicolor light mode, the time t1 for which light is emitted in the particular color is longer than the time t2 for switching the color. Thus, even for the babies and infants awkward at operating the toothbrush, the favorite colors can be calmly selected.

Moreover, according to the toothbrush of the present invention, the single button can turn on the power source and can switch the light emission mode. Thus, the device configuration can be simplified, and it is not necessary to memorize the button types and functions. Thus, even the babies and the infants can easily perform operation.

Further, according to the toothbrush of the present invention, the light source includes the LEDs of three primary colors, and therefore, three or more light colors such as seven rainbow colors of red, orange, yellow, green, blue, navy, and pink can be reproduced.

### BRIEF DESCRIPTION OF THE DRAWINGS

FIG. 1A is an external view of a toothbrush according to one embodiment of the present invention.

FIG. 1B is an external view of the toothbrush according to one embodiment of the present invention.

FIG. 1C is a front view of the toothbrush according to one embodiment of the present invention.

FIG. 1D is a back view of the toothbrush according to one embodiment of the present invention.

FIG. 1E is a left side view of the toothbrush according to one embodiment of the present invention.

FIG. 1F is a right side view of the toothbrush according to one embodiment of the present invention.

FIG. 1G is a plan view of the toothbrush according to one embodiment of the present invention.

FIG. 1H is a bottom view of the toothbrush according to one embodiment of the present invention.

FIG. 1I is an enlarged view of a prism cut included in the toothbrush according to one embodiment of the present invention.

FIG. 2 is a circuit diagram of a drive control circuit of the toothbrush according to one embodiment of the present invention.

FIG. 3 is a chart for describing a light emission pattern of the toothbrush according to one embodiment of the present invention.

FIG. 4 is a flowchart of control performed by a control unit of the toothbrush according to one embodiment of the present invention.

### DETAILED DESCRIPTION

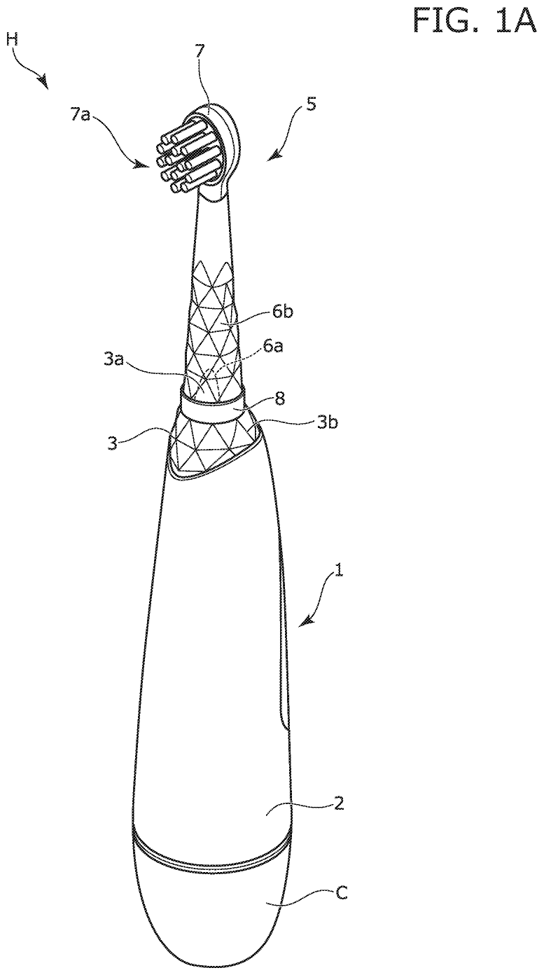

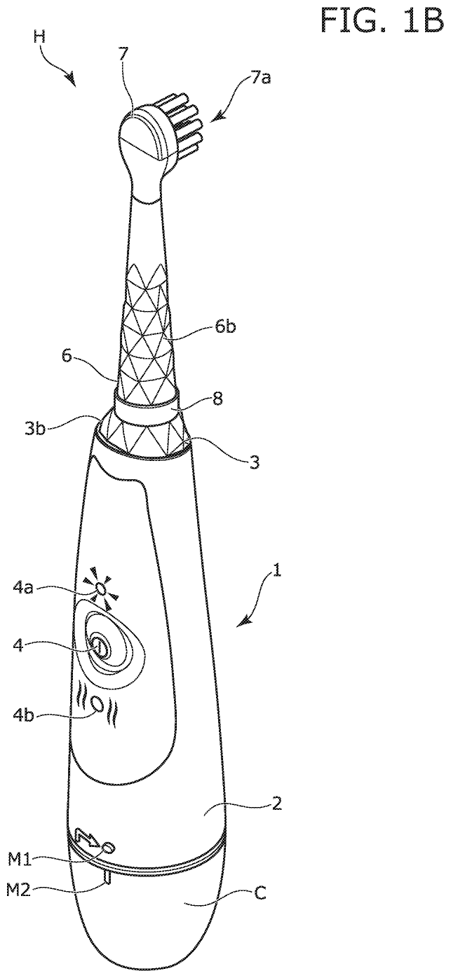

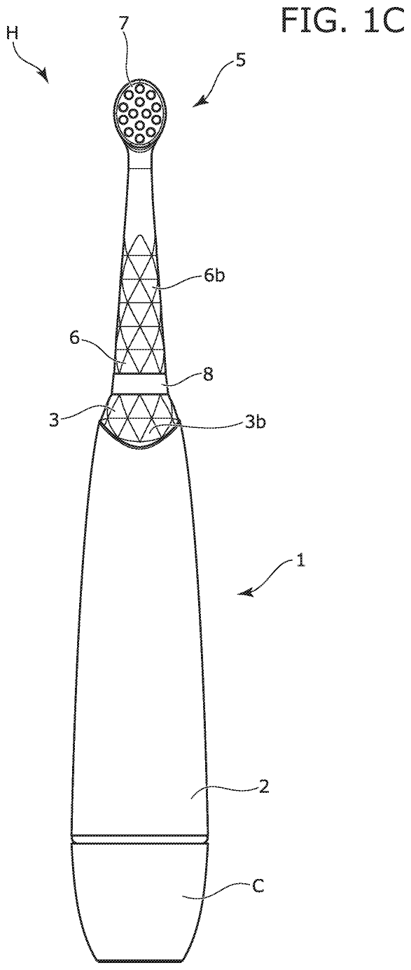

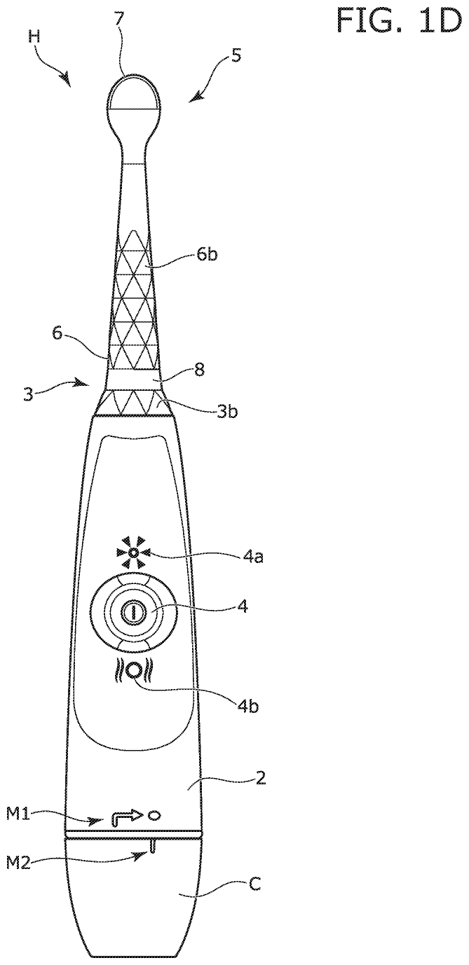

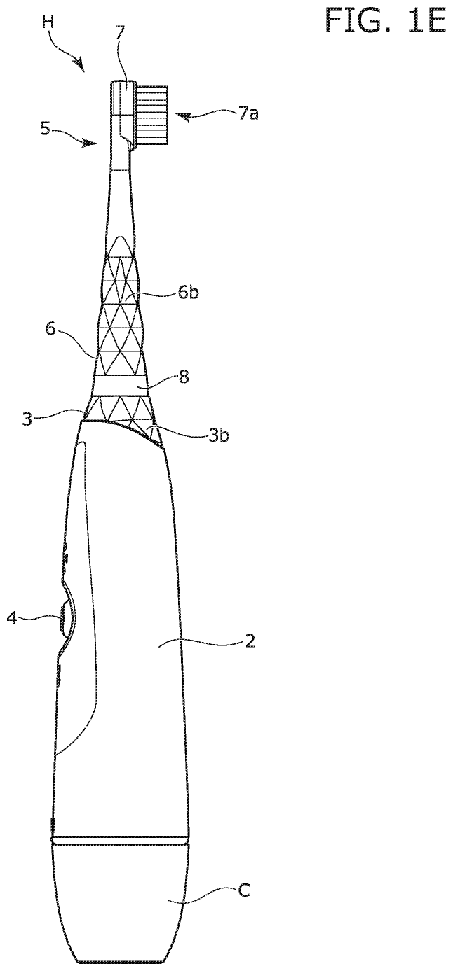

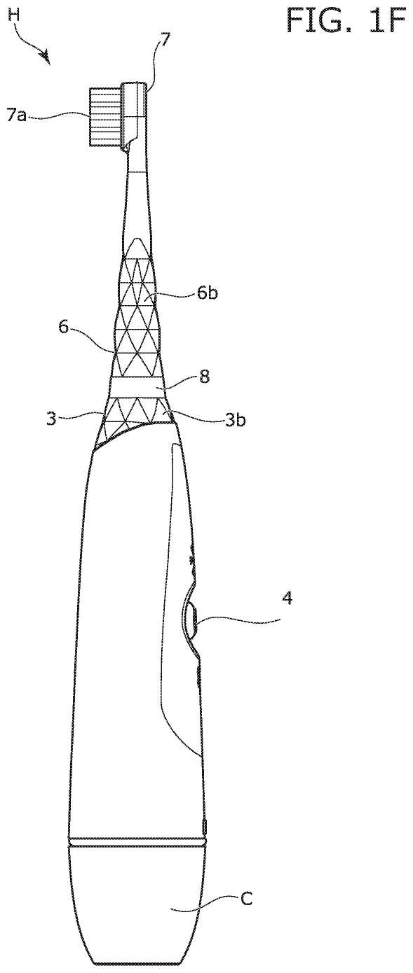

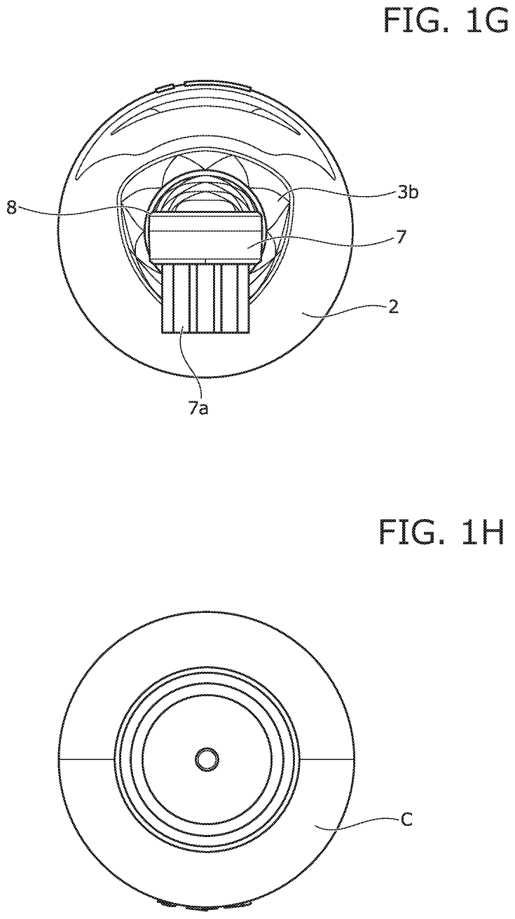

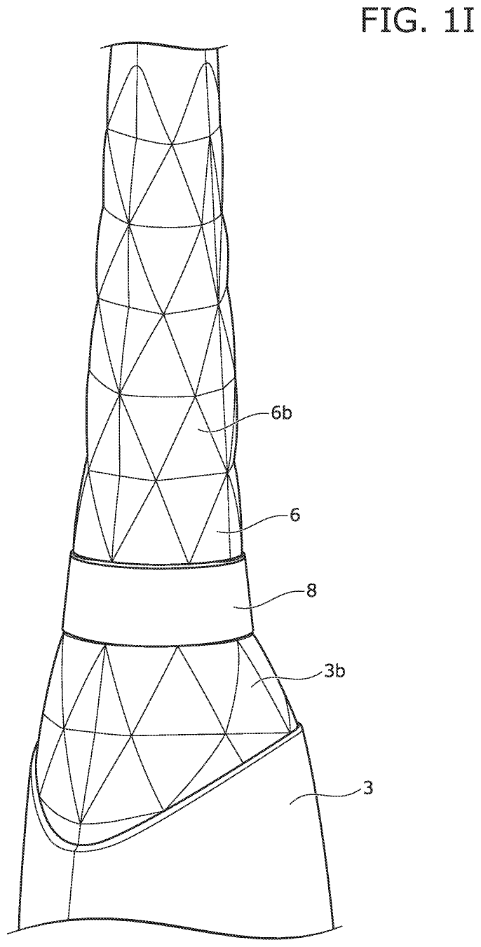

Hereinafter, a toothbrush according to an embodiment (hereinafter referred to as a “present embodiment”) of the present invention will be described with reference to FIGS. 1 to 4. A toothbrush for a child will be described as an example of the toothbrush according to the present embodiment, but the present invention is not limited to one for the child.

Note that the embodiment described below is merely one example for the sake of easy understanding of the present invention, and is not intended to limit the present invention. That is, change and modification can be made to shapes, dimensions, arrangements, etc. of members described below without departing from the gist of the present invention, and needless to say, the present invention includes equivalents thereof.

<Toothbrush H>

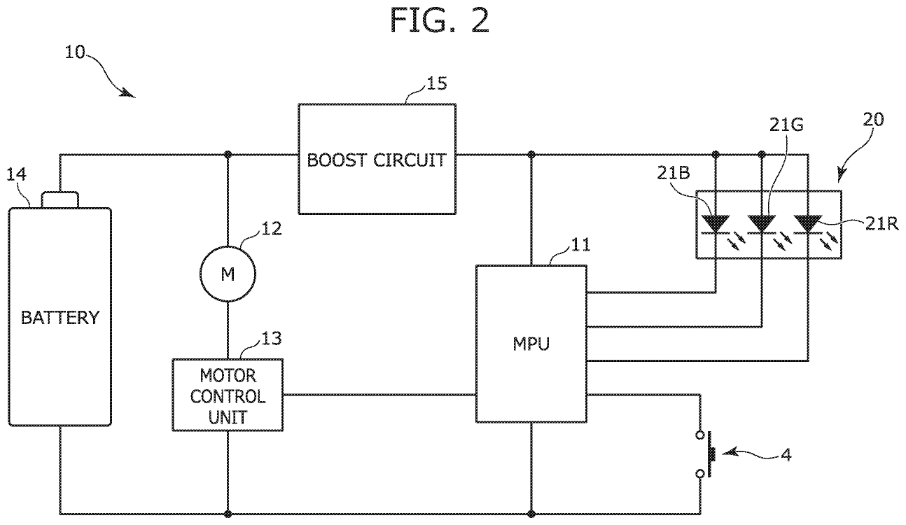

As illustrated in FIGS. 1A, 1B, and 2, a toothbrush H according to the present embodiment is a toothbrush H including a built-in light source 20, and includes a body portion 1 housing the light source 20 and a battery 14, a brush portion 5 provided at a tip end portion 3 of a housing 2 of the body portion 1, a MPU 11 as a control unit configured to control a light emission mode of the light source 20, and an operation button 4 for controlling the MPU 11.

Views of six sides of the toothbrush H according to the present embodiment are illustrated in FIGS. 1C to 1H. FIG. 1C is a front view of the toothbrush H, FIG. 1D is a back view of the toothbrush, FIG. 1E is a left side view of the toothbrush, FIG. 1F is a right side view of the toothbrush, FIG. 1G is a plan view of the toothbrush, and FIG. 1H is a bottom view of the toothbrush.

(Body Portion 1)

As illustrated in FIGS. 1A and 1B, the body portion 1 includes the housing 2 as a gripping portion upon use of the toothbrush H and the tip end portion 3 provided at a tip end of the housing 2. At the tip end portion 3, a fitting raised portion 3a for detachably connecting the later-described brush portion 5 is formed. A prism cut 3b is formed at an outer peripheral surface of the tip end portion 3, and reflects light inward without light leakage to the outside.

FIG. 1I is an enlarged view of the prism cut 3b, and illustrates the shape of the prism cut 3b. The prism cut 3b is configured such that triangular surfaces are connected to form the outer peripheral surface of the tip end portion 3, and is arranged at a position continuous to a circular portion of a brush base end portion 6 above the prism cut 3b. Thus, light emitted from the light source 20 is reflected on the prism cut 3b at an optional angle, and therefore, various reflection states can be enjoyed depending on the angle of viewing the prism cut 3b.

The operation button 4 is a single operation unit included in the toothbrush H, and is provided at such a position that the operation button 4 can be operated from the outside of the housing 2. As described below in detail, the operation button 4 fulfills a role as a power button and a mode switching button.

As illustrated in FIG. 1B, a light emission mark 4a indicating light emission is provided above the operation button 4, and a vibration mark 4b indicating vibration is provided below the operation button 4. That is, the operation button 4 is operated such that a user recognizes that a light emission pattern can be controlled or vibration can be turned on.

Note that the housing 2 is made of hard plastic, and on the other hand, the operation button 4 and a region therearound are made of a rubber material having elasticity. Thus, a better user's feeling of gripping is provided. Moreover, the shape of the housing 2 can be an optional shape, and for example, the section of the housing 2 may be in a triangular shape so that a better user's feeling of gripping can be provided. Since the sectional shape of the housing 2 is the triangular shape, the toothbrush H can be easily gripped in either of a case where children of younger ages and children of various ages grip the toothbrush H or a case where parents grip the toothbrush H.

As illustrated in FIGS. 1A and 1B, a cover cap C for replacing the battery is provided at a lower end of the housing 2. The cover cap C is detachably attached to the lower end of the housing 2. The cover cap C can be detached from the housing 2 and a battery holder (not shown) can be exposed in such a manner that the cover cap C is rotated relative to the body portion 1 such that a first marker m1 and a second marker m2 are shifted from each other. After the battery has been loaded in the battery holder, the cover cap C is rotated until the first marker m1 and the second marker m2 become coincident with each other, and in this manner, the cover cap C can be attached to the housing 2.

(Brush Portion 5)

The brush portion 5 as a mouth cleaning brush head is, as illustrated in FIGS. 1A and 1B, configured such that the brush base end portion 6 forms a fitting recessed portion 6a in which the fitting raised portion 3a formed at the tip end portion 3 of the housing 2 can be fitted. Many resin bristles 7a are implanted in a tip end 7 of the brush portion 5. The entirety or a large portion of the brush portion 5 is made of a transparent resin material having favorable light transparency.

For example, acrylic resin, epoxy resin, saturated polyester resin, methacryl resin, fluorene-based transparent resin, styrene-based transparent resin, transparent ABS resin, or polypropylene resin can be used as the transparent resin material. Specifically, high-strength polyethylene terephthalate (PETG) or thermoplastic elastomer (TPE) is preferably used. Note that for the resin bristles 7a, various transparent resin materials such as nylon and polyester can be used.

A prism cut 6b is formed at an outer peripheral surface of the brush base end portion 6, and reflects light inward without light leakage to the outside. Moreover, a collar ring 8 is provided as a user's identification ring at the brush base end portion 6. Collar rings 8 in different colors are prepared for different brush portions 5, and therefore, can be used differently among brothers or sisters (users).

FIG. 1I is an enlarged view of the prism cut 6b, and illustrates the shape of the prism cut 6b. The prism cut 6b is configured such that triangular surfaces are connected to each other, and is arranged at a position continuous to a circular portion of an upper portion of the brush base end portion 6. Thus, light emitted from the light source 20 is reflected on the prism cut 6b at an optional angle, and therefore, various reflection states can be enjoyed depending on the angle of viewing the prism cut 6b.

The toothbrush H is for the child. The weight of the toothbrush H except for the battery 14 is about 35 g, and the size of the toothbrush H is a height (H) of about 170 mm (168 mm) , a width (W) of about 25 mm (26 mm) , and a depth (D) of about 25 mm (26 mm). Thus, the toothbrush H fits a child's hand.

<Drive Control Circuit 10>

The toothbrush H includes, in the housing 2, a drive control circuit 10. As illustrated in FIG. 2, the drive control circuit 10 has the MPU 11 as the (main) control unit, a vibration motor 12, a motor control unit 13, the battery 14, a boost circuit 15, and the light source 20.

(MPU 11)

The MPU 11 is a general microprocessor (Micro Processing Unit), and fulfills a role as the main control unit (a control device) configured to control each component of the toothbrush H.

(Vibration Motor 12)

In a later-described monochromatic light mode M2 and a white light mode M3, the MPU 11 controls the motor control unit 13 to supply power from the battery 14 to the vibration motor 12, thereby vibrating the housing 2 by operation of the vibration motor 12. Vibration of the housing 2 is transmitted to the brush portion 5 fitted onto and supported on the fitting raised portion 3a, and the tip end 7 provided with the resin bristles 7a is vibrated 16,000 times per minute, for example.

(Battery 14)

It is assumed that, e.g., a DC 1.5V triple A alkaline battery is used as the battery 14 as a power source, but a button battery or a chargeable secondary battery may be used. The battery 14 is housed in the battery holder (not shown) at the lower end of the housing 2, and the detachable cover cap C is provided at the lower end of the housing 2 so that the battery 14 can be replaced.

(Boost Circuit 15)

The boost circuit 15 applies a voltage suitable for the light source 20, specifically a voltage increased to the rated voltage (e.g., 3.3 V) of a light-emitting diode (LED) upon light emission, to the light source 20, thereby causing the light source 20 to emit light. The light from the light source 20 enters the brush portion 5 fitted onto and supported on the fitting raised portion 3a.

(Light Source 20)

As illustrated in FIG. 2, the light source 20 is a color LED light built in the housing 2 of the body portion 1, and includes only three LEDs of a red LED 21R, a green LED 21G, and a blue LED 21B. The toothbrush H according to the present embodiment is equipped with the LEDs of three types of color, i.e., three primary colors (red, green, blue). The toothbrush H performs such control that the intensity of emission from each LED is changed such that light in three or more colors such as seven rainbow colors of red, orange, yellow, green, blue, navy, and pink is emitted in a visual sense (in other words, light colors more than the number of LEDs included in the light source 20 (the types of color of the LEDs) can be reproduced).

The toothbrush H is waterproof, and has waterproof/dustproof performance equivalent to IPX7 according to protection standards set by IEC (International Electrotechnical Commission). Even if the toothbrush H is temporarily (30 minutes) in water under a certain water depth condition (1 m), the water does not enter the toothbrush H, and the toothbrush H can be used with a sense of security at a bathroom.

<Light Emission Mode>

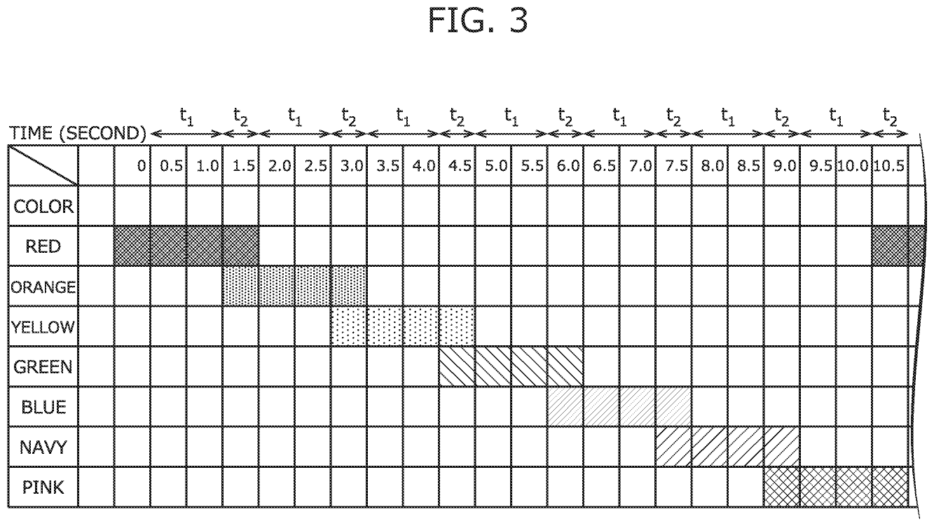

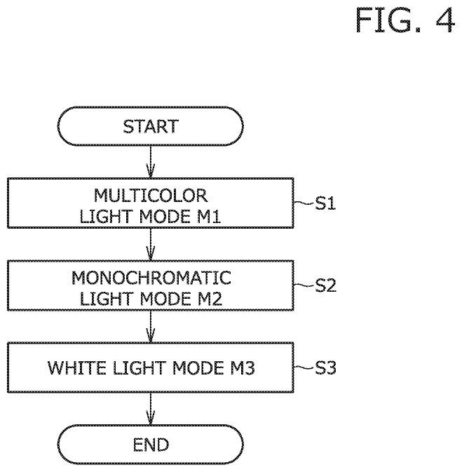

In the toothbrush H according to the present embodiment, the MPU 11 controls light emission from the light source 20 such that the light emission mode is switched in the order of a multicolor light mode M1, the monochromatic light mode M2, and the white light mode M3 every time the operation button 4 is pressed and operated from a power OFF state. Hereinafter, each light emission mode will be described with reference to FIGS. 3 and 4.

(Multicolor Light Mode M1)

In the multicolor light mode M1, the MPU 11 switches light in at least three or more colors to control light emission from the light source 20 (a step S1 of FIG. 4) as illustrated in FIG. 3, for example. In the power OFF state, when the operation button 4 as the power button of the toothbrush H is pressed once, power is supplied from the battery 14 to the light source 20, and the light source 20 sequentially lights up while changing the light color in the order of seven rainbow colors, specifically in the order of red, orange, yellow, green, blue, navy, pink, red, . . . (FIG. 3). That is, in the multicolor light mode M1, the light source 20 emits light while switching at least three or more colors (e.g., seven colors).

At this point, when the light color of the light source 20 is switched from a certain color (a first color) to another color (a second color), the MPU 11 controls the light source 20 such that time t1 for which light in either one of the certain color (the first color) or another color (the second color) is emitted is longer than time t2 for which the certain color (the first color) is switched to another color (the second color) (FIG. 3). Note that upon switching from the certain color to another color, the color before switching will be defined as the first color and the color after switching will be defined as the second color.

In a specific example, light is first emitted in red (the first color) for one second (t1) in a fixed manner upon transition from red to orange. Next, upon switching between red (the first color) and orange (the second color) , light is emitted in a mixed color of red and orange (a mixed color of the first color and the second color) for 0.5 seconds (t2) (a lighting change). Then, light is emitted in orange (the second color) for one second (t1) in a fixed manner.

In such a configuration, in the multicolor light mode M1, the time t1 for which light is emitted in a particular color (the certain color (the first color) or another color (the second color)) is longer than the time t2 for switching the color. Thus, even for babies and infants awkward at operating the toothbrush H, favorite colors can be calmly selected.

The number of colors in the multicolor light mode M1 is not limited to seven colors, and may be at least three or more colors such as three to six colors or eight or more colors. Moreover, the types of color are not limited to red, orange, yellow, green, blue, navy, and pink, and other colors can be employed.

(Monochromatic Light Mode M2)

In the monochromatic light mode M2, the MPU 11 performs such control that the light source 20 continuously emits, in a fixed manner, light in the particular color selected from at least three or more colors (a step S2 of FIG. 4). That is, in the monochromatic light mode M2, light is emitted in the particular color selected from at least three or more colors (e.g., seven colors) in a fixed manner.

Specifically, in the multicolor light mode M1, the operation button 4 is pressed to transition control of the light source 20 by the MPU 11 from the multicolor light mode M1 to the monochromatic light mode M2. In other words, when the operation button 4 is operated in the multicolor light mode M1, the MPU 11 performs such control that control of the light source 20 transitions to the monochromatic light mode M2, and in this manner, the light source 20 emits light in the color (the particular color) of light emitted upon operation of the operation button 4.

Specifically, the child using the toothbrush H presses the operation button 4 once again at the timing of emitting light in the particular color from the light source 20 in the multicolor light mode M1, and in this manner, sequential lighting of the light source 20 can be stopped and light emission from the light source 20 can be continuously performed in an optional favorite color (the particular color) in a fixed manner.

In such a configuration, the child operates the operation button 4 during lighting in the favorite color in the multicolor light mode M1 for sequentially switching the light color, and in this manner, the multicolor light mode M1 transitions to the monochromatic light mode M2 for emitting light in the child's favorite color. That is, the child can brush the teeth while light in the favorite color is being emitted by voluntary operation, and therefore, the effect of putting the toothbrush into the mouth without refusal and lifting the mood for tooth brushing is provided.

Note that light is emitted in the mixed color of the first color and the second color for 0.5 seconds (t2) upon switching between the first color and the second color (the lighting change), but in the case of operating the operation button 4 during such a period, light is continuously emitted in either one of the first color or the second color from the light source 20 in a fixed manner. In this case, considering time lag until the operation button 4 is pressed and operated after the child has noticed one's favorite color, in a case where the operation button 4 is operated while light is being emitted in the mixed color of the first color and the second color for 0.5 seconds (t2) (the lighting change), light is preferably continuously emitted in the first color (a previously-displayed color) from the light source 20 in a fixed manner.

(White Light Mode M3)

In the white light mode M3, the MPU 11 performs such control that light is emitted in white from the light source 20 in a fixed manner (a step S3 of FIG. 4). That is, in the white light mode M3, the light source 20 can emit light in white in a fixed manner.

Specifically, in the monochromatic light mode M2, the operation button 4 is operated such that control of the light source 20 by the MPU 11 transitions from the monochromatic light mode M2 to the white light mode M3. In other words, when the operation button 4 is operated in the monochromatic light mode M2, the MPU 11 performs such control that control of the light source 20 transitions to the white light mode M3.

According to such a configuration, after the child has brushed the teeth in the monochromatic light mode M2 for emitting light in the favorite color selected by the child, a change to the white light mode M3 for emitting white light, with which the parent easily finishes up tooth brushing and insufficient brushing is easily checked, from the light source 20 can be performed by the simple operation of pressing the operation button 4.

(Drive of Vibration Motor 12)

The body portion 1 includes the vibration motor 12 as a vibration source in the housing 2, and the MPU 11 controls the motor control unit 13 such that power is supplied from the battery 14 to the vibration motor 12 in the monochromatic light mode M2 and the white light mode M3. That is, in the monochromatic light mode M2 and the white light mode M3, vibration is generated.

According to such a configuration, when the child brushes the teeth in the monochromatic light mode M2 for emitting light in the favorite color selected by the child or when the parent illuminates the inside of the child's mouth with the white light to finish up tooth brushing in the white light mode M3, vibration is transmitted from the body portion 1 to the brush portion 5 so that, e.g., stain, food debris, and plaque on and between the teeth can be easily removed with a favorable efficiency. Moreover, the vibration motor 12 is not operated in the multicolor light mode M1, and therefore, unnecessary power consumption can be avoided and the child can calmly select one's favorite color.

(Off of Power Supply)

In the white light mode M3, the operation button 4 is operated to stop power supply from the battery 14 to the light source 20 and the vibration motor 12, and in this manner, the power source of the toothbrush H is turned off. Moreover, it is configured such that in any mode, the power source is automatically turned off after a lapse of two minutes from last operation of the operation button 4, and therefore, environment-friendly safe design is realized.

As described above, the toothbrush H according to the present embodiment includes only the single operation button 4 as the operation unit. The operation button 4 is operated such that the MPU 11 performs power supply from the battery 14 to the light source 20, transition from the multicolor light mode M1 to the monochromatic light mode M2, and transition from the monochromatic light mode M2 to the white light mode M3.

According to such a configuration, the single operation button 4 can turn on the power source and can switch the light emission mode. Thus, a device configuration can be simplified, and it is not necessary to memorize button types and functions. Thus, even babies and infants can easily perform operation.

Note that in the above-described embodiment, the operation button 4 is pressed once again in the multicolor light mode M1 to stop sequential lighting of the light source 20 and continuously emit light in the color (the particular color) of light upon operation of the operation button 4, i.e., the optional favorite color (the particular color), from the light source 20 in a fixed manner. However, in a case where the operation button 4 is pressed once again in the multicolor light mode M1, the MPU 11 may perform such control that light is continuously emitted in an optional color (a random color) from the light source 20 in a fixed manner.

With randomness in the light color of the light source 20 fixed upon operation of the operation button 4 in the multicolor light mode M1, child's interest can be awaken.

Moreover, in the multicolor light mode M1, the value of the time t1 for which light is emitted in the particular color (the certain color (the first color) or another color (the second color)) and the value of the time t2 for which the color is switched may be adjusted as necessary. For example, the values of t1 and t2 may be adjusted according to babies' and infants' ages in month and year so that lighting time can be adjusted to optimal lighting time according to babies' and infants' developmental stages.

### SUMMARY

When the teeth grow and need to be brushed, the mother generally brushes the child's teeth, and it is important to create environment for avoiding child's refusal of tooth brushing. The toothbrush H according to the present embodiment can sequentially emit light in seven rainbow colors while the child voluntarily fixes the light color to the optional favorite color (transition from the multicolor light mode M1 to the monochromatic light mode M2). At this point, such a game element that the operation button 4 is pressed to fix lighting at the predetermined timing of light emission in the favorite color from the light source 20 is produced. That is, the child voluntarily selects, during tooth brushing, light emission while enjoying the favorite color, and therefore, the effect of putting the toothbrush into the mouth without refusal and lifting the mood for tooth brushing is provided regardless of age in month and year. Thus, the child can establish the habit of actively brushing the teeth.

Moreover, in order for the parent to finish up tooth brushing subsequently after the child oneself has brushed the teeth, the color selected by the child can transition, by simple operation, to the white light with which the parent easily finishes up tooth brushing and insufficient brushing is easily checked (e.g., from a state in which light is emitted in the color selected by the child, the operation button 4 as the power button is further pressed once again). That is, not only the toothbrush can be put into the child's mouth without refusal and the mood for tooth brushing can be lifted, but also finishing brushing and checking of insufficient brushing can be easily performed.

### DESCRIPTION OF REFERENCE NUMERALS

H toothbrush
1 body portion
2 housing
3 tip end portion

3a fitting raised portion

3b prism cut
4 operation button (operation unit)

4a light emission mark

4b vibration mark
5 brush portion
6 brush base end portion

6a fitting recessed portion

6b prism cut
7 tip end

7a resin bristle
8 collar ring
C cover cap
m1 first marker
m2 second marker
10 drive control circuit
11 MPU (control unit)
12 vibration motor (vibration source)
13 motor control unit
14 battery (power source)
15 boost circuit
16 light source

21R red LED

21G green LED

21B blue LED

What is claimed is:

1. A toothbrush including a built-in light source, comprising:
a body portion configured to house the light source and a power source;
a brush portion provided at a tip end portion of the body portion;
a control unit configured to control a light emission mode of the light source; and
an operation unit configured to control the control unit,
wherein the light source is able to emit light in a multicolor light mode for switchably emitting light in at least three or more colors and a monochromatic light mode for emitting light in a particular color selected from the at least three or more colors in a fixed manner, and
when the operation unit is operated in the multicolor light mode, the control unit performs such control that control of the light source transitions to the monochromatic light mode, and accordingly, the light source emits light in a color of light emitted upon operation of the operation unit.

2. The toothbrush according to claim 1, wherein
the light source is able to emit light in a white light mode for emitting white light in a fixed manner, and
when the operation unit is operated in the monochromatic light mode, the control unit performs such control that the control of the light source transitions to the white light mode.

3. The toothbrush according to claim 2, wherein
the body portion includes a vibration source in a housing, and
the control unit supplies power from the power source to the vibration source in the monochromatic light mode and the white light mode.

4. The toothbrush according to claim 1, wherein
when a color from the light source is switched from a first color to a second color in the multicolor light mode, the control unit controls the light source such that time t1 for which light is emitted in either one of the first color or the second color is longer than time t2 for which the first color is switched to the second color.

5. The toothbrush according to claim 1, wherein
the operation unit includes a single operation button, and
the operation button is operated such that the control unit performs power supply from the power source to the light source and transition from the multicolor light mode to the monochromatic light mode.

6. The toothbrush according to claim 1, wherein
the light source includes a red LED, a green LED, and a blue LED.
